(19) United States
(12) Patent Application Publication
(10) Pub. No.: US 2008/0192288 A1
(43) Pub. Date: Aug. 14, 2008

(54) Network facsimile machine and image forming device

(75) Inventors: Mitsuhiro Kitamura, Osaka (JP); Masahiro Nishiyama, Osaka (JP); Yoshiaki Yasui, Osaka (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 12/012,145

(22) Filed: Jan. 30, 2008

(30) Foreign Application Priority Data
Feb. 8, 2007 (JP) 2007-028694
Feb. 8, 2007 (JP) 2007-028695

(51) Int. Cl. G06F 3/12

(52) U.S. Cl. 358/1.15; 358/402

(57) ABSTRACT

According to a first network facsimile machine 11 among network facsimile machines of the present invention, for example, a main control section 17 makes a domain determination whether an electronic mail having been transmitted is from a domain of an important other party by referring to a domain management table in a domain registration section 35 as appropriate. When a determination that the electronic mail having been transmitted is from a domain of an important other party is made, as a result of the domain determination, the main control section 17 serves so as to raise a priority level of a job associated with the electronic mail. Therefore, a job related to the domain registered as the important other party is processed with priority through properly managing a priority level of a job on a network. As a result, a latency time until a job related to electronic mail having been transmitted from an important other party is started can be reduced as short as possible.

### TECHNICAL FIELD

This invention relates to a network facsimile machine capable of properly managing a priority level of a job on a network and an image forming device equipped with the network facsimile machine.

### BACKGROUND ART

Conventionally, a network facsimile machine performing document communications on a network by utilizing an electronic mail function has been known. As an example of such a network facsimile machine, Japanese Published Unexamined Patent Application No. 2003-8799 discloses art wherein a facsimile machine provided with a receiving section receiving image data with the use of a plurality of communications protocols is configured to control a printing priority level of every communications protocol. According to the prior art described in Japanese Published Unexamined Patent Application No. 2003-8799, priority level control over a printing job by taking advantage of immediacy of the communications protocol can be realized.

However, the foregoing prior art is configured to uniformly set a priority order based on a preset priority level of every communications protocol, so that there is concern that a certain latency time is constrained until a job is started even if the job is, for example, a receiving job of an electronic mail which has been transmitted from an important party on the other end or a job related to a logon user who has completed logging onto the network such as an authenticated user.

### SUMMARY OF THE INVENTION

Accordingly, an object of the present invention is to provide a network facsimile machine capable of properly managing a priority level of a job on a network.

In order to achieve the foregoing object, a network facsimile machine in accordance with the present invention has a gist of including a priority management section managing a priority level of a job on a network including electronic mail communications and a condition registration section in which a condition for a job whose priority level needs to be raised is registered, wherein the priority management section determines the presence or absence of a job satisfying the registered condition in the condition registration section and, when a determination that there exists a relevant job is made, as a result of the determination, raises a priority level of the relevant job.

In addition, the condition registration section can be configured such that one or more domain names on the network are registered as a condition for a job whose priority level needs to be raised, and the priority management section can be configured to determine the presence or absence of a job related to the registered domain name and, when a determination that there exists a relevant job is made, as a result of the determination, raise a priority level of the relevant job.

Furthermore, the job related to the registered domain name can be receiving processing of an electronic mail having been transmitted from a relevant domain.

Still furthermore, an informing section informing a relevant user of completion of the job when the receiving processing of the electronic mail is completed may be further provided.

Moreover, the job related to the registered domain name can be printing processing of a document attached with an electronic mail having been transmitted from a relevant domain.

An informing section informing a relevant user of completion of the job when the printing processing of the document attached with the electronic mail is completed may be further provided.

Furthermore, when there exists a job related to the registered domain name and when a job related to electronic mail communications is processed by a manual operation of a user, the priority management section can be configured to raise a priority level of the job related to the registered domain name.

Alternatively, the condition registration section can be configured such that being a job related to an authenticated user on the network is registered as a condition for a job whose priority level needs to be raised, and the priority management section can be configured to determine the presence or absence of a job related to the authenticated user and, when a determination that there exists a relevant job is made, as a result of the determination, raise a priority level of the relevant job.

In addition, the job related to the authenticated user can be receiving processing of an electronic mail.

Furthermore, an informing section informing a relevant user of completion of the job when the receiving processing of the electronic mail is completed may be further provided.

Moreover, the job related to the authenticated user may be printing processing of a document attached with an electronic mail.

An informing section informing a relevant user of completion of the job when the printing processing of the document attached with the electronic mail is completed can be further provided.

Furthermore, when there exists a job related to the authenticated user and when a job related to electronic mail communications is processed by a manual operation of a user, the priority management section can be configured to raise a priority level of the job related to the authenticated user.

An image forming device equipped with the network facsimile machine in accordance with the present invention and applied to management of a job on a network including electronic mail communications can be acquired.

### OPERATION AND EFFECTS OF THE INVENTION

In the facsimile machine of the present invention, the priority management section determines the presence or absence of a job satisfying a registered condition in the condition registration section and, when a determination that there exists a relevant job is made, as a result of the determination, raises a priority level of the relevant job. Accordingly, for example, when one or more domain names on the network are registered as a condition for a job whose priority level needs to be raised, in the condition registration section, a job related to the registered domain is processed with priority. On the other hand, when being a job related to an authenticated user on the network is registered as a condition for a job whose priority level needs to be raised, in the condition registration section, a job related to the authenticated user is preferentially processed. Therefore, a latency time until a job related to an electronic mail having been transmitted from an important party on the other end is started or a latency time until a job related to a user having completed logging onto the network is started can be reduced as short as possible through properly managing a priority level of a job on the network.

### BRIEF DESCRIPTION OF THE DRAWINGS

FIG. 1 is a block diagram showing an overview of an image forming device and its periphery, equipped with a network facsimile machine in accordance with a first embodiment of the present invention;

FIG. 2 is a block diagram showing an overview of the network facsimile machine and its periphery in accordance with the first embodiment of the present invention;

FIG. 3 is an operational flowchart of the network facsimile machine in accordance with the first embodiment of the present invention;

FIG. 4 is a block diagram showing an overview of an image forming device and its periphery, equipped with a network facsimile machine in accordance with a second embodiment of the present invention;

FIG. 5A is a diagram showing an example of a user management table used in the network facsimile machine in accordance with the second embodiment of the present invention;

FIG. 5B is a diagram showing an example of an account management table used in the network facsimile machine in accordance with the second embodiment of the present invention; and

FIG. 6 is an operational flowchart of the network facsimile machine in accordance with the second embodiment of the present invention.

### DESCRIPTION OF THE PREFERRED EMBODIMENTS

Hereinafter, a network facsimile machine in accordance with embodiments of the present invention and an image forming device are described in detail with reference to the drawings. As an example of a network facsimile machine in accordance with embodiments of the present invention, an explanation is given below by referring to an example in which a network facsimile machine is applied to management of a job on a network including electronic mail communications.

### A First Network Facsimile Machine 11 of a First Embodiment

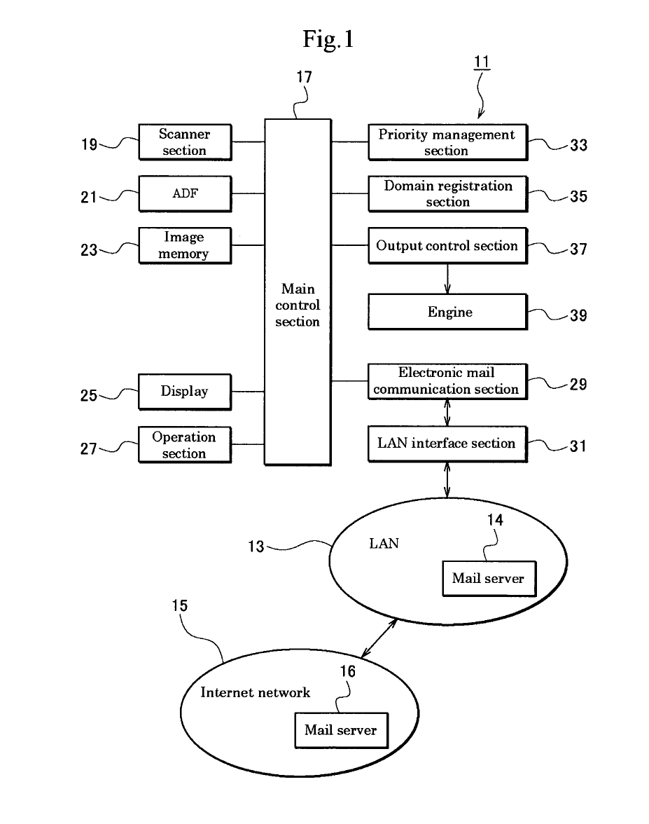

First, a first network facsimile machine 11 in accordance with a first embodiment is described with reference to FIGS. 1 to 3.

### (Configuration of the First Network Facsimile Machine 11 and its Periphery)

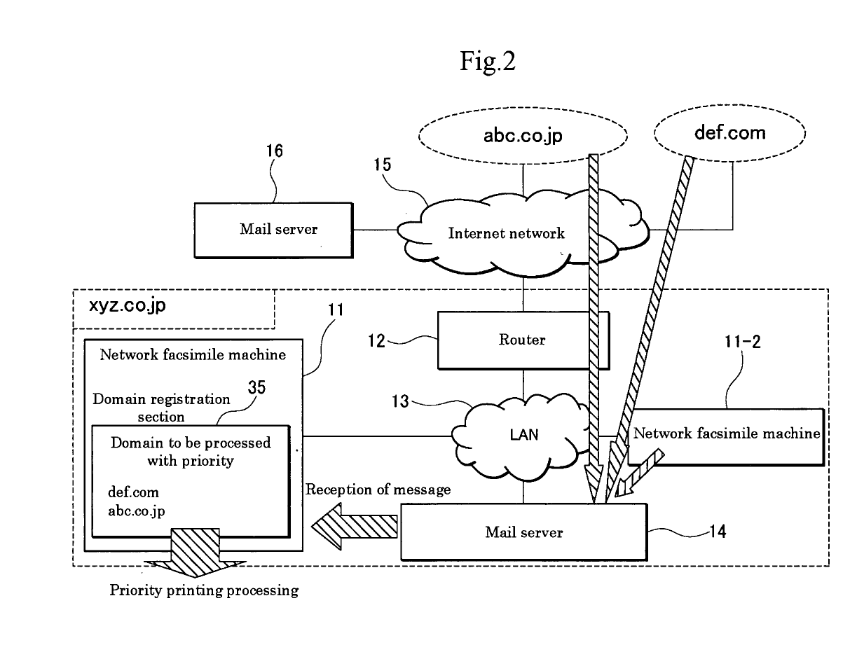

As shown in FIGS. 1 and 2, the first network facsimile machine 11 of the first embodiment is compliant with International Telecommunication Union Telecommunication Standardization Sector (ITU-T) T. 37 recommendation and is connected to a local area network (LAN) 13 constructed in a business establishment whose domain name is ‘xyz.co.jp,’ for example. The LAN 13 is connected to an Internet network 15 via a router 12.

The first network facsimile machine 11 can transmit an image file corresponding to a document image to any electronic mail address on the Internet network 15 via the LAN 13. The transmission of the image file is achieved by a transmission side of writing electronic mail including the image file on a mail server 16 placed on the Internet network 15 and on the other hand a reception side of taking out electronic mail addressed to itself from the mail server 16. A terminal corresponding to an electronic mail address of a destination maybe a personal computer or another network facsimile machine.

As shown in FIG. 1, the first network facsimile machine 11 includes a main control section 17 (corresponding to a part of a ‘priority management section’ in the present invention) taking charge of control over the entire device, a scanner section 19 optically reading out an image of a document, an automatic document feeder (ADF) 21 for automatically supplying a document to the scanner section 19, an image memory 23 for storing image data output by the scanner section 19, a display 25 (corresponding to an ‘informing section’ in the present invention) composed of a liquid crystal display panel, etc., an operation section 27 used in inputting an operation such as an address, message, attachment of an image file of an electronic mail, an electronic mail communication section 29 for carrying out electronic mail communications, a LAN interface section 31 mediating a data exchange between the electronic mail communication section 29 and the LAN 13, a priority management section 33 (corresponding to a part of a ‘priority management section’ in the present invention), a domain registration section 35 (corresponding to a ‘condition registration section’ in the present invention), an output control section 37 and an engine 39.

The electronic mail communication section 29 creates an image file corresponding to image data stored on the image memory 23 as an attached file, creates electronic mail by attaching the created attached file to the electronic mail and transmits the created electronic mail. On the other hand, the electronic mail communication section 29 receives electronic mail (including one attached with an image file) which has been transmitted via the Internet network 15 and the LAN 13 sequentially.

The priority management section 33 centrally controls a priority level for processing of various jobs in connection with a client (a personal computer or another network facsimile machine) on the LAN 13.

The domain registration section 35 includes a domain management table (see reference numeral 35 in FIG. 2, for example) in which, as management information of an important party on the other end, a domain name of the important other party is written. Every time electronic mail is transmitted from various other parties, the main control section 17 cooperates with the priority management section 33 to refer to the domain management table in the domain registration section 35 as appropriate, thereby made is a domain determination whether the transmitted electronic mail is from the domain of the important other party. When a determination that the electronic mail is from the domain of the important other party is made, as a result of the domain determination, the main control section 17 functions to raise a priority level of the job associated with the electronic mail.

The engine 39 prints out image data which has been read out by the scanner section 19, image data which has been transmitted from a client personal computer (PC) via the LAN 13 or image data into which an image file attached with electronic mail received via the electronic mail communication section 29 has been decompressed, on a sheet of recording paper based on a printing control signal delivered by the output control section 37.

The thus configured first network facsimile machine 11 is assigned with one or more mail accounts. The first network facsimile machine 11 can receive electronic mail from a personal computer on the Internet network 15 or another Internet facsimile machine as shown in reference numeral 11-2 of FIG. 2, for example. When an image file is attached with the electronic mail, the network facsimile machine 11 can decompress the image file into its original image and print out the image on a sheet of the recording paper if necessary.

In addition, the first network facsimile machine 11 can carry out the same electronic mail communications as above with the respective terminal devices (a personal computer, another Internet facsimile machine, etc.) on the LAN 13 by using a mail server 14 in the LAN 13. That is, the terminal device with which the first network facsimile machine 11 can communicate is not limited to one on the Internet network 15 as long as data communications by electronic mail is possible.

### (Operations of the First Network Facsimile Machine)

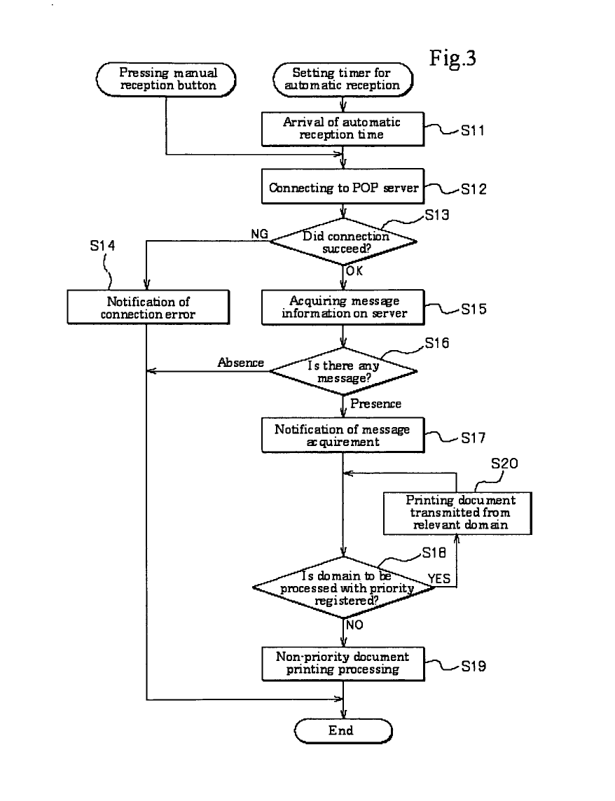

Subsequently, operations of the first network facsimile machine 11 in accordance with the first embodiment of the present invention are described with reference to FIG. 3.

First, an operation when a communications mode for electronic mail in the first network facsimile machine 11 is set to be in an automatic receiving mode for, for example, carrying out electronic mail communications at preset time intervals such as intervals of 10 minutes is described. When an automatic receiving time arrives (Step S11), the main control section 17 carries out processing of connecting to a POP server (the mail server 14 shown in FIG. 1 or 2) via the electronic mail communication section 29 (Step S12). Next, the main control section 17 makes a determination of success or failure in the connecting processing (Step S13). When the connecting processing fails for some reason, as a result of the connection success or failure determination, the main control section 17 notifies a connection error by displaying on the display 25 that the connection error has occurred (Step S14). After that, the main control section 17 terminates the whole processing.

On the other hand, when the connecting processing succeeds, as a result of the connection success or failure determination in Step S13, the main control section 17 carries out processing of acquiring message information on a mail account assigned to the first network facsimile machine 11 by accessing a relevant mail box in the mail server 14 via the electronic mail communication section 29 (Step S15). Subsequently, the main control section 17 makes an acquirement or non-acquirement determination whether message information has been acquired in Step S15 (Step S16). When there is no message information, as a result of the acquirement or non-acquirement determination, the main control section 17 terminates the whole processing.

On the other hand, when there is message information, as a result of the acquirement or non-acquirement determination in Step S16, the main control section 17 provides a notification of the message acquirement by displaying on the display 25 that message information has been acquired (Step S17). Next, the main control section 17 cooperates with the priority management section 33 to refer to the domain management table in the domain registration section 35 as appropriate, thereby made is a domain determination whether the electronic mail having been transmitted is from a domain of an important other party (Step S18). When a determination that the electronic mail having been transmitted is not from a domain of an important other party is made, as a result of the domain determination in Step S18, the main control section 17 delivers a command to perform regular printing processing to the output control section 37. In response thereto, the engine 39 carries out the regular printing processing (Step S19).

On the other hand, when a determination that the electronic mail having been transmitted is from a domain of an important other party is made, as a result of the domain determination in Step S18, the main control section 17 updates priority information in the priority management section 33 so as to raise a priority level of a job associated with the electronic mail (corresponding to a ‘job related to the printing processing for image data attached with the electronic mail’ in the first embodiment). Responding to that, the main control section 17 delivers a command to process the printing job associated with the electronic mail with priority to the output control section 37, whereupon the engine 39 performs printing processing according to the priority level (Step S20). More specifically, as shown in FIG. 2, when a determination that the electronic mail having been transmitted is from a domain registered as an important other party such as ‘abc.co.jp’ or ‘def.com’ is made, the main control section 17 raises a priority level of a job relevant to the electronic mail.

A loop processing from Steps S18 to S20 is repeated until the electronic mail having been transmitted is determined as not being from a domain of an important party on the other end.

Meanwhile, every time the printing processing is completed, an appropriate user can be informed when the printing processing is carried out with the priority level raised in Step S20. As a mode of the informing, for example, a message such as ‘printing of a document addressed to User A has been completed’ may be displayed on the display 25. Alternatively, a beeper may be sounded with the intention of alerting. Still alternatively, they may be used in combination to inform the user.

An operation in a case where the electronic mail communications mode in the first network facsimile machine 11 is set to be in a manual receiving mode is that the processing in Step S11 is omitted and the processing subsequent to Step S12 described above is carried out every time the user performs an input operation related to the manual reception. The priority information in the priority management section 33 may be updated only when the first network facsimile machine 11 of the present invention is set to be in the manual receiving mode. On the contrary, the priority information in the priority management section 33 may be updated only when the first network facsimile machine 11 of the present invention is set to be in the automatic receiving mode.

### Effects of the First Embodiment

According to the first network facsimile machine 11 of the first embodiment, every time electronic mail is transmitted from various other parties, the main control section 17 cooperates with the priority management section 33 to refer to the domain management table in the domain registration section 35 as appropriate, thereby made is a domain determination whether the transmitted electronic mail is from a domain of an important other party. When a determination that the transmitted electronic mail is from a domain of an important other party is made, as a result of the domain determination, the main control section 17 serves so as to raise a priority level of a job associated with the electronic mail. Consequently, a job related to the domain registered as the important other party is processed with priority through properly managing a priority level of a job on the network. As a result, a latency time until the job related to the electronic mail having been transmitted from the important other party is started can be reduced as short as possible.

According to an image forming device equipped with the first network facsimile machine 11, an image forming device capable of reducing, as short as possible, a latency time until a job related to electronic mail having been transmitted from an important other party is started can be acquired.

### [A Second Network Facsimile Machine 41 of a Second Embodiment

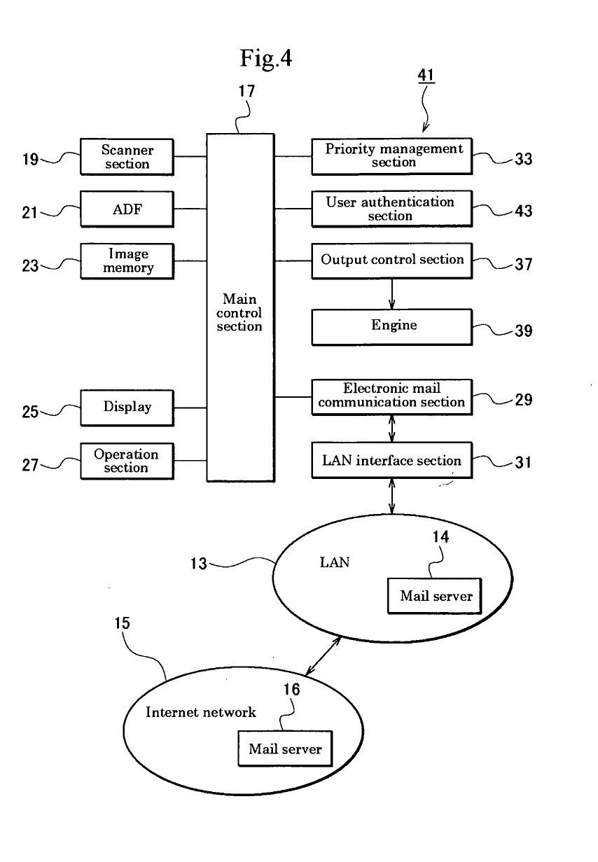

Subsequently, a second network facsimile machine 41 in accordance with a second embodiment is described with reference to FIGS. 4 to 6. Some configurations of functional sections are in common between the first network facsimile machine 11 described above and the second network facsimile machine 41 described below. Therefore, the same symbols are given to the common functional sections between the first and second network facsimile machines 11 and 41, and differences between them are described with focus while overlapped description is omitted.

### (Configuration of the Second Network Facsimile Machine 41 Itself and its Periphery)

Although the domain registration section 35 is employed in the first network facsimile machine 11 as a functional section corresponding to a ‘condition registration section’ of the present invention, a user authentication section 43 is employed in the second network facsimile machine 41 as the functional section corresponding to a ‘condition registration section’ of the present invention.

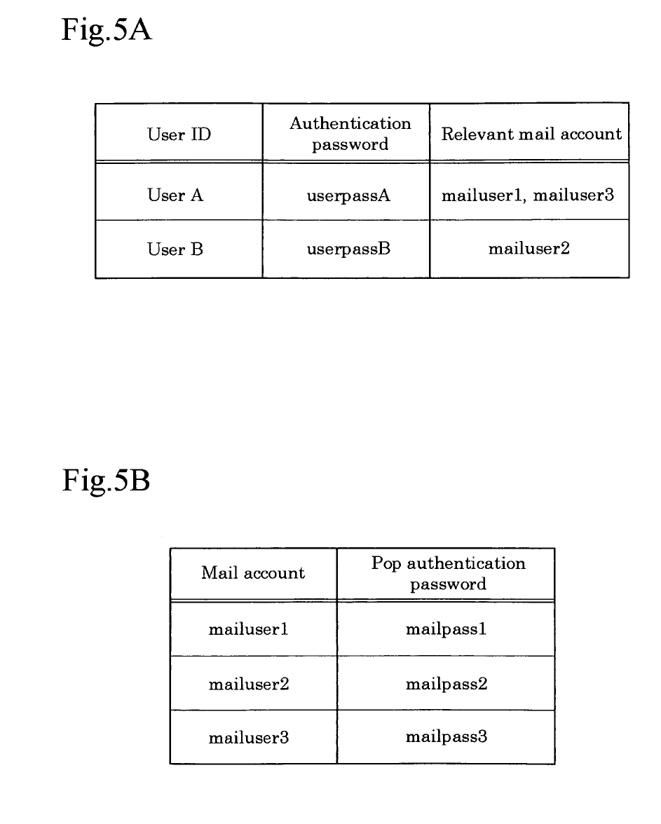

As management information for a user of logging onto the LAN 13, the user authentication section 43 includes a user management table (see FIG. 5A, for example) composed to associate an authentication password and relevant mail account information with each user identification information for allowing identifying a plurality of users uniquely and an account management table (see FIG. 5B, for example) composed to associate a POP authentication password with each mail account information. Every time the user attempts to log onto the LAN 13, the user authentication section 43 refers to the foregoing management tables as appropriate, thereby performed is user authentication whether the user attempting to log on is a regular registered user. When a determination that the user attempting to log on is a regular registered user is made, as a result of the user authentication processing, the user authentication section 43 serves so as to permit the user to access the LAN 13. A concept of a user in the present invention includes a personal user (including a case of sharing one client computer with a plurality of personal users) as a minimum unit among clients on the LAN 13 and a group user to which a plurality of personal users belong. Therefore, if a group user is permitted to log on by the user authentication section 43, a personal user belonging to the relevant group can access the LAN 13. Here, in use of the second network facsimile machine 41, there are cases where the user uses the device 41 without authentication and where the user uses the device 41 after authentication. There is also a case where the user uses the device 41 after logging on via the above-described group management function. As a mode of the user authentication, a mode for inputting a user identification ID and a password via the operation section 27 or a mode for using an IC card stored with a user identification ID and a password is conceivable.

### (Operations of the Second Network Facsimile Machine)

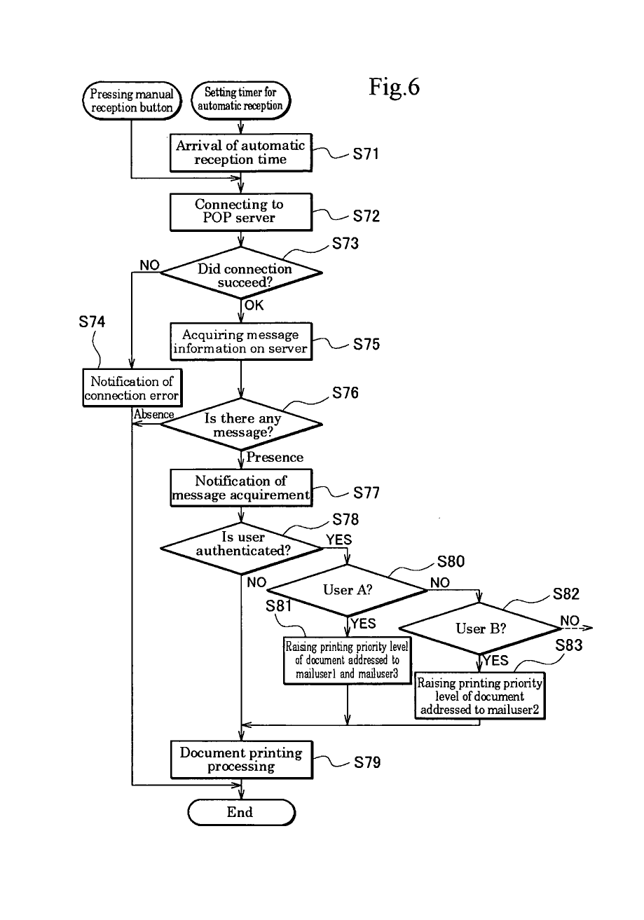

Next, operations of the second network facsimile machine 41 in accordance with the second embodiment of the present invention are described with reference to FIG. 6.

First, an operation when a communications mode for electronic mail in the second network facsimile machine 41 is set to be in an automatic receiving mode for, for example, carrying out electronic mail communications at preset time intervals such as intervals of 10 minutes is described. When an automatic receiving time arrives (Step S71), a main control section 17 performs processing of connecting to a POP server (a mail server 14 in FIG. 4) via an electronic mail communication section 29 (Step S72). Subsequently, the main control section 17 makes a determination of success or failure in the connecting processing (Step S73). When the connecting processing fails for some reason, as a result of the connection success or failure determination, the main control section 17 provides a notification of a connection error by displaying on a display 25 that the connection error has occurred (Step S74), thereafter the whole processing is terminated.

On the other hand, when the connecting processing succeeds, as a result of the connection success or failure determination in Step S73, the main control section 17 accesses a relevant mail box on the server 14 via the electronic mail communication section 29, thereby carried out is processing of acquiring message information related to a mail account assigned to the second network facsimile machine 41 (Step S75). Subsequently, the main control section 17 makes an acquirement or non-acquirement determination whether message information has been acquired in Step S75 (Step S76). When there is no message information, as a result of the acquirement or non-acquirement determination, the main control section 17 terminates the whole processing.

On the other hand, when there is message information, as a result of the acquirement or non-acquirement determination in Step S76, the main control section 17 provides a message acquirement notification by displaying on the display 25 that message information has been acquired (Step S77). Next, the user authentication section 43 makes a user authentication determination whether the user is authenticated (Step S78).

When a determination that the user is not authenticated is made, as a result of the user authentication determination in Step S78, the main control section 17 delivers a command to carry out regular printing processing to an output control section 37. In response thereto, an engine 39 carries out the regular printing processing (Step S79).

On the other hand, when a determination that the user is authenticated is made, as a result of the user authentication determination in Step S78, the main control section 17 cooperates with a priority management section 33 to further make a user authentication determination whether ‘User A’ among users registered in the user management table as shown in FIG. 5A, for example, is authenticated (Step S80). When a determination that ‘User A’ is authenticated is made, as a result of the user authentication determination in Step S80, the main control section 17 updates priority information in the priority management section 33 so as to raise a priority level of a job (a job related to the printing processing in the second embodiment) related to ‘mailuser1’ and ‘mailuser3’ which are mail accounts associated with ‘User A’ (Step S81). In response thereto, the main control section 17 delivers to the output control section 37 a command to preferentially process the printing job related to ‘mailuser1’ and ‘mailuser3’ which are mail accounts associated with ‘User A,’ whereupon the engine 39 carries out printing processing according to the priority level (Step S79).

On the other hand, when a determination that ‘User A’ is not authenticated is made, as a result of the user authentication determination in Step S80, the main control section 17 cooperates with the priority management section 33 to further make a user authentication determination whether ‘User B’ among the users registered in the user management table in FIG. 5A is authenticated (Step S82). When a determination that ‘User B’ is authenticated is made, as a result of the user authentication determination in Step S82, the main control section 17 updates priority information in the priority management section 33 so as to raise a priority level of a job (a job related to the printing processing in the second embodiment) related to ‘mailuser2’ which is a mail account associated with ‘User B’ (Step S83). In response thereto, the main control section 17 delivers to the output control section 37 a command to preferentially process the printing job related to ‘mailuser2’ which is the mail account associated with ‘User B,’ whereupon the engine 39 carries out printing processing according to the priority level (Step S79).

Meanwhile, when the printing processing is completed, an appropriate user can be informed if the printing processing is carried out with a priority level raised in Step S79. As a mode of the informing, for example, a message such as ‘printing of a document addressed to User A has been completed’ may be displayed on the display 25. Alternatively, a beeper may be sounded with the intention of alerting. Still alternatively, they may be used in combination to inform the user.

An operation when the electronic mail communications mode in the second network facsimile machine 41 is set to be in a manual receiving mode is that the processing in Step S71 is omitted and the processing subsequent to Step S72 described above is carried out every time the user performs an input operation of manual reception. The priority information in the priority management section 33 may be updated only when the second network facsimile machine 41 is set to be in the manual receiving mode.

### Effects of the Second Embodiment

According to the second network facsimile machine 41 of the second embodiment, the priority management section 33 determines the presence or absence of a user having been authenticated by the user authentication section 43. When there is a relevant authenticated user, as a result of the determination, the priority management section 33 functions so as to raise a priority level of a job (a printing job in the embodiment) related to the relevant authenticated user. Therefore, the job related to the authenticated user is processed with priority through properly managing a priority level of a job on the network. As a result, a latency time until a job related to a user who has completed logging onto the network is started can be reduced as short as possible.

Further, according to an image forming device equipped with the second network facsimile machine 41, an image forming device capable of reducing, as short as possible, a latency time until a job related to a user who has completed logging onto the network is started can be acquired.

### [Other]

The present invention is not limited to the above-described embodiments and can be modified as appropriate within a range that does not depart from the spirit or the technical idea of the present invention understood from the claims and the description. A network facsimile machine and an image forming device with such a modification are to fall within the technical scope of the present invention.

That is, a printing job related to image data attached with electronic mail having been transmitted from a domain registered in the domain registration section 35 is exemplified, and a mode for raising a priority level of the printing job is exemplarily described in the first embodiment of the present invention. However, the present invention is not restricted to the embodiment, and may be configured to employ an acquiring job of an electronic mail message having been transmitted from a domain registered in the domain registration section 35 to raise a priority level related to the acquirement of the message, for example.

In addition, a printing job is exemplified as the job related to the authenticated user, and a mode for raising a priority level of the printing job is exemplarily described in the second embodiment of the present invention. However, it is obvious that the present invention is not restricted to the embodiment and may employ an acquiring job of an electronic mail message as the job related to the authenticated user to raise a priority level of the acquirement of the message, for example.

What is claimed is:

1. A network facsimile machine comprising:
a priority management section managing a priority level of a job on a network including electronic mail communications; and
a condition registration section in which a condition for a job whose priority level needs to be raised is registered, wherein the priority management section determines the presence or absence of a job satisfying the registered condition in the condition registration section and, when a determination that there exists a relevant job is made, as a result of the determination, raises a priority level of the relevant job.

2. The network facsimile machine according to claim 1, wherein one or more domain names on the network are registered as a condition for a job whose priority level needs to be raised, in the condition registration section, and
the priority management section determines the presence or absence of a job related to the registered domain name and, when a determination that there exists a relevant job is made, as a result of the determination, raises a priority level of the relevant job.

3. The network facsimile machine according to claim 2, wherein the job related to the registered domain name is receiving processing of electronic mail having been transmitted from the relevant domain.

4. The network facsimile machine according to claim 3, further comprising an informing section informing a relevant user of completion of the job when the receiving processing of the electronic mail is completed.

5. The network facsimile machine according to claim 2, wherein the job related to the registered domain name is printing processing of a document attached with electronic mail having been transmitted from the relevant domain.

6. The network facsimile machine according to claim 5, further comprising an informing section informing a relevant user of completion of the job when the printing processing of the document attached with the electronic mail is completed.

7. The network facsimile machine according to claim 2, wherein the priority management section raises a priority level of a job related to the registered domain name when there exists a job related to the registered domain name and when a job related to electronic mail communications is processed by a manual operation of a user.

8. The network facsimile machine according to claim 1, wherein being a job related to an authenticated user on the network is registered as a condition for a job whose priority level needs to be raised, in the condition registration section, and
the priority management section determines the presence or absence of a job related to the authenticated user and, when a determination that there exists a relevant job is made, as a result of the determination, raises a priority level of the job.

9. The network facsimile machine according to claim 8, wherein the job related to the authenticated user is receiving processing of an electronic mail.

10. The network facsimile machine according to claim 9, further comprising an informing section informing a relevant user of completion of the job when the receiving processing of the electronic mail is completed.

11. The network facsimile machine according to claim 8, wherein the job related to the authenticated user is printing processing of a document attached with electronic mail.

12. The network facsimile machine according to claim 11, further comprising an informing section informing a relevant user of completion of the job when the printing processing of the document attached with the electronic mail is completed.

13. The network facsimile machine according to claim 8, wherein the priority management section raises a priority level of a job related to the authenticated user when there exists a job related to the authenticated user and when a job related to electronic mail communications is processed by a manual operation of a user.

14. An image forming device equipped with the network facsimile machine according to claim 1, wherein the network facsimile machine is applied to management of a job on a network including electronic mail communications.
